(19) United States
(12) Patent Application Publication
(10) Pub. No.: US 2009/0059351 A1
(43) Pub. Date: Mar. 5, 2009

(54) DEMODULATOR SYSTEM AND METHOD USING MULTILEVEL DIFFERENTIAL PHASE SHIFT KEYING

(75) Inventors: LEI XU, PRINCETON, NJ (US); TING WANG, PRINCETON, NJ (US); JIANJUN YU, PRINCETON, NJ (US); PHILIP NAN JI, PRINCETON, NJ (US); YUTAKA YANO, CHIBA (JP)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/050,538

(22) Filed: Mar. 18, 2008

Related U.S. Application Data
(60) Provisional application No. 60/956,808, filed on Aug. 20, 2007.

(51) Int. Cl. G02F 2/00

(52) U.S. Cl. 359/325

(57) ABSTRACT

A demodulator and demodulation method includes an optical coupler configured to receive an input signal. The optical coupler couples the signal to an even number of branches. Each branch including at least one interferometer configured to split, combine and interfere with an optical signal from one of within the branch or from another branch. A common optical delay is disposed on one of every two branches between the optical coupler and the interferometer of the branch.

### RELATED APPLICATION INFORMATION

This application claims priority to provisional application Ser. No. 60/956,808 filed on Aug. 20, 2007, incorporated herein by reference.

### BACKGROUND

1. Technical Field

The present invention relates to optical communications and more particularly to a demodulator and method of operations using multilevel differential phase shift keying (MDPSK).

2. Description of the Related Art

Differential phase shift keying modulations have been quite attractive for high-speed optical wavelength division multiplexing (WDM) communications because of higher receiver sensitivity and better tolerance to fiber nonlinearity than conventional intensity modulations. Compared with binary differential phase shift keying (BDPSK) modulation, multilevel (M) differential phase shift keying (MDPSK, M-DPSK, or mDPSK) can transmit multiple information bits with one symbol or baud. The symbol/baud rate of an M level modulation is

$$\frac{1}{{log}_{2} M}$$

times the bit rate. Therefore, the spectral efficiency of a multilevel modulation can be improved by a factor of log₂M when compared to a binary modulation, whose symbol rate is the same as the bit rate.

Besides offering high spectral efficiency, multilevel modulation is also an important technology which can be leveraged to support the existing network migration from low bit rate (e.g. 10 Gb/s or lower) to next-generation high bit rate (e.g. 40 Gb/s, 100 Gb/s or higher) systems. Because the high bit rate is achieved at a relatively low symbol rate, a multi-level modulation system can have better tolerance to chromatic dispersion (CD) and polarization mode dispersion (PMD) than the systems with binary modulations, and have better compatibility with the existing fiber plants which were designed to run at low bit rates. For example, 40 Gb/s optical BDPSK signals are 16 times less tolerant to CD and 4 times less tolerant to PMD than conventional 10 Gb/s intensity modulated signals, while 40 Gb/s optical DQPSK signals are only 4 times less tolerant to CD and twice less tolerant to PMD than conventional 10 Gb/s intensity modulated signals.

With differential quadrature phase shift keying (DQPSK) modulation, it is quite possible to eliminate the need for PMD compensators and tunable dispersion compensators in 40 Gb/s long haul transmission and increase the compatibility of 40 Gb/s transmission with many legacy networks.

Despite these advantages, since MDPSK modulation uses more discrete states of phase, the complexity of receiving optical MDPSK signals is much higher than that of receiving BDPSK signals. In MDPSK modulation format, each differential phase between successive bits can have a value of 0, 2π/M, 4π/M, 6π/M, . . . , (M−1) 2π/M. Each coded symbol carries log₂M bits of information. There can be different ways of generating MDPSK signals. A general scheme is to cascade log₂M phase modulators, and each of the phase modulator is modulated by a data stream at bit rate of B/log₂M, where B is the system aggregated bit rate.

Compared with binary DPSK optical systems, optical MDPSK communication systems require more complex receivers to identify the different signal levels. For an optical MDPSK demodulator, the frequency offset tolerance between the laser and the delay interferometer is much less than for binary DPSK. For example, the frequency offset tolerance of a DQPSK demodulator is about six times less than that of a binary DPSK demodulator under the same bit rate. Therefore, feedback loop controls over an MDPSK demodulator are necessary to maintain the system performance when the transmitter laser frequency drifts over time. Therefore, a need exists for a system and method that benefits from the use of MDPSK but can reduce its complexity.

### SUMMARY

The present embodiments provide optical MDPSK demodulators which are employed in a system to convert optical MDPSK signals into intensity modulated signals. A new MDPSK demodulator design is disclosed, which can reduce the number of feedback control loops and therefore simplify optical MDPSK signal receiving. The new demodulator design for MDPSK modulation formats illustratively includes DQPSK and 8DPSK. With the new design, the operation of an optical MDPSK receiver can be simplified, and better device flexibility can be achieved to support optical communications at different bit rates.

A demodulator and demodulation method includes an optical coupler configured to receive an input signal. The optical coupler couples the signal to an even number of branches. Each branch includes at least one interferometer configured to split, combine and interfere with an optical signal from one of within the branch or from another branch. A common optical delay is disposed on one of every two branches between the optical coupler and the interferometer of the branch.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a constellation diagram showing M phase codes demodulated using M/2 phase thresholds in accordance with a conventional MDPSK scheme;

FIG. 2 is a schematic diagram showing a conventional direct detection optical MDPSK demodulator;

FIG. 3A is a constellation diagram showing demodulation of optical DQPSK signals with two phase thresholds in accordance with the present principles;

FIG. 3B is a constellation diagram showing demodulation of optical 8DPSK signals with four phase thresholds in accordance with the present principles;

FIG. 4 is a schematic diagram showing an optical MDPSK signal demodulator in accordance with one embodiment;

FIG. 5 is a schematic diagram showing an optical DPSK signal demodulator in accordance with another embodiment;

FIG. 6 is a schematic diagram showing an optical 8DPSK signal demodulator using four interferometers based upon the DQPSK design of FIG. 5 in accordance with one embodiment;

FIG. 7 is a schematic diagram showing an optical 8DPSK signal demodulator using four interferometers based upon the design of FIG. 4 in accordance with one embodiment;

FIG. 8 is a schematic diagram showing an optical 8DPSK signal demodulator using two interferometers in accordance with one embodiment;

FIG. 9 is a diagram showing free-space optics employed in an optical DQPSK signal demodulator in accordance with one embodiment;

FIGS. 10 and 11 are diagrams showing alternative designs for the free-space optics employed in the optical DQPSK signal demodulator of FIG. 9 without circulators in accordance with one embodiment; and

FIG. 12 is a schematic diagram showing an optical signal demodulator using adjustable free-space optics in accordance with an embodiment.

### DETAILED DESCRIPTION OF PREFERRED EMBODIMENTS

Differential phase shift keying modulations have been adopted for high-speed optical WDM communications due to their advantages of supporting longer transmission distance and having higher receiver sensitivity. Multilevel differential phase shift keying (MDPSK, where M may refer to the number of signal levels), such as quadrature differential phase shift keying (QDPSK or DQPSK), can transmit multiple (log₂M) bits within one symbol period. Compared with binary differential phase shift keying (BDPSK) modulation, MDPSK can have higher spectral efficiency and better tolerance to fiber polarization mode dispersion (PMD) and chromatic dispersion (CD).

However, one of the challenges in optical MDPSK system implementations comes from the more complex receivers which need to have stable operation of converting the received optical MDPSK signal from phase modulation to intensity modulation. A new demodulator design for applications in optical MDPSK signal receiving includes an optical MDPSK receiver which has simplified operation, and better flexibility to support different communication bit rates and technologies. For example, the present principles may be employed in fiber optics, free-space optics, PLC optics, etc.

Embodiments described herein may be entirely hardware, entirely software or including both hardware and software elements. In a preferred embodiment, the present invention is implemented in hardware but may have software elements, which may include but are not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

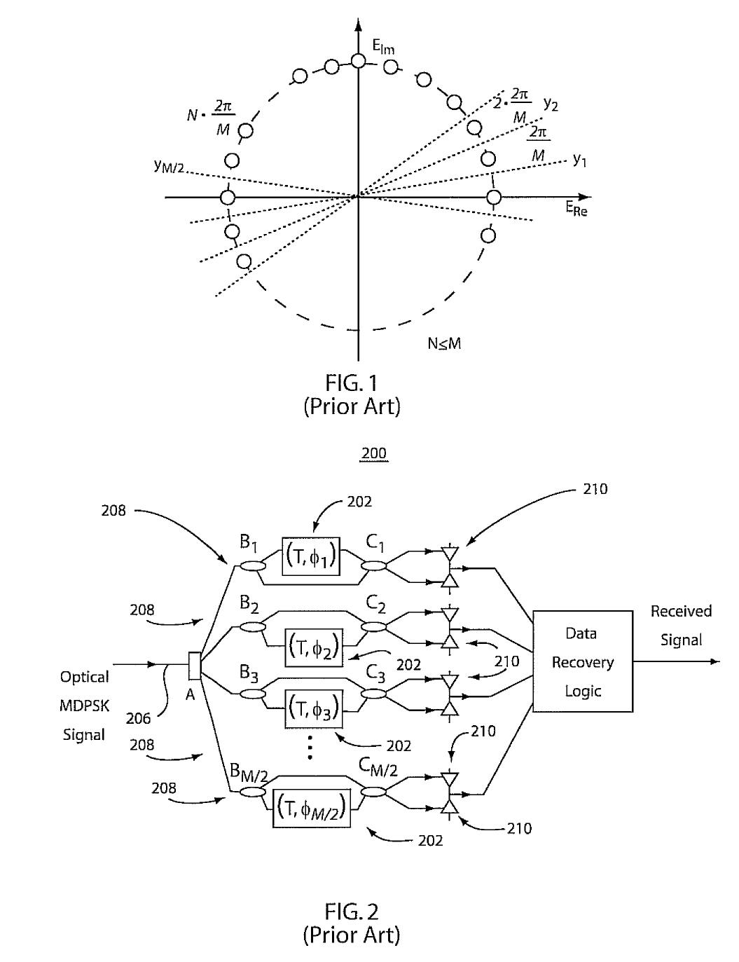

Referring now to the drawings in which like numerals represent the same or similar elements and initially to FIG. 1, a constellation is shown for optical MDPSK signals where the axes are real (E_{Re}) and imaginary (E_{Im}) portion or the electric field for receiving of optical MDPSK signals. In principle, the MDPSK format has m phase codes 102 and needs M/2 phase thresholds (y₁, y₂, . . . y_{M/2}, etc.) (we assume M is an even number for most cases).

Referring to FIG. 2, a structure of an optical MDPSK signal receiver 200 is illustratively shown in accordance with a conventional design. With direct detection, the MDPSK signal receiver 200 can be constructed by M/2 delay interferometers 202 in parallel, and each delay interferometer 202 is set at an optical threshold (y in FIG. 1). An incoming optical MDPSK signal 206 is split equally into M/2 branches 208, and each passes through a delay interferometer 202 (B₁C₁, B₂C₂, B₃C₃, . . . , or B_{M/2}C_{M/2}). The delay interferometer can cause the interference of the signal with its delayed self (delay T), and therefore converts the signal from phase modulation to intensity modulation, which can be detected by optoelectronic detectors 210. The optical delay T is decided by the symbol rate of the incoming optical MDPSK signal. T is usually equal to or close to the symbol period to guarantee sufficient overlap of neighboring bits during interference. Each delay interferometer 202 has different phase bias φ for different thresholds (y). The balanced detectors 210 following the delay interferometers 202 can have higher receiver sensitivity than single-end detectors. B₁, B₂, B₃, . . . , B_{M/2}, and C₁, C₂, C₃, . . . , C_{M/2}, are 3 dB couplers, which ideally split the input signal with splitting ratio 50:50.

An electrical signal after a delay interferometer 202 with balanced detection 210 can be expressed as:

$$i ( f ) = \frac{{RA}^{2}}{M} \cdot cos ( 2 π f T + {φ}_{DI} + Δφ ) \qquad ( 1 )$$

where A is the amplitude of the lightwave carrier, R is the photodetector responsivity, f is the lightwave carrier frequency, φ_{DI} is the phase bias of the delay interferometer, and Δφ is the phase difference of the neighboring bits. In optical MDPSK signal demodulation, fT should be an integer.

In optical MDPSK communications, a large M enables one symbol to carry more information bits. At the same time, a large M reduces the minimal distance of two constellation points and causes ambiguity and decision errors at the receiver side. DQPSK modulation has been applied at 40 Gb/s optical communications in the field. When M>4, optical MDPSK modulation has not been implemented. Optical DQPSK and 8DPSK are employed as examples to compare the present design with conventional designs. However, the present embodiments are applicable to other modulation and demodulations schemes.

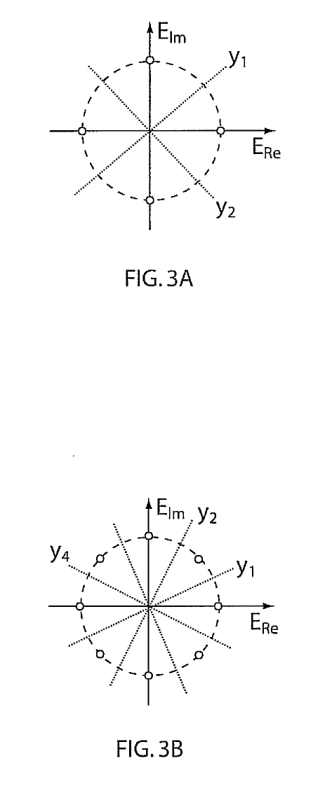

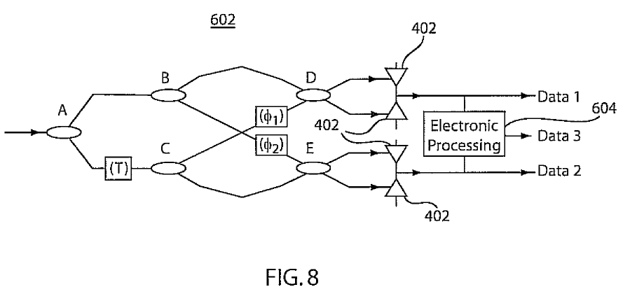

Referring to FIGS. 3A and 3B, the demodulation of optical DQPSK (FIG. 3A) and 8DPSK (FIG. 3B) signals with two phase thresholds (y) and four phase thresholds (y), respectively in accordance with the present principles. In optical DQPSK signal demodulation (FIG. 3A), y₁=π/4, and y₂=π/4. In optical 8DPSK demodulation (FIG. 3B), y₁=π/8, y₂=3π/8, y₃=−3π/8, and y₄=−π/8.

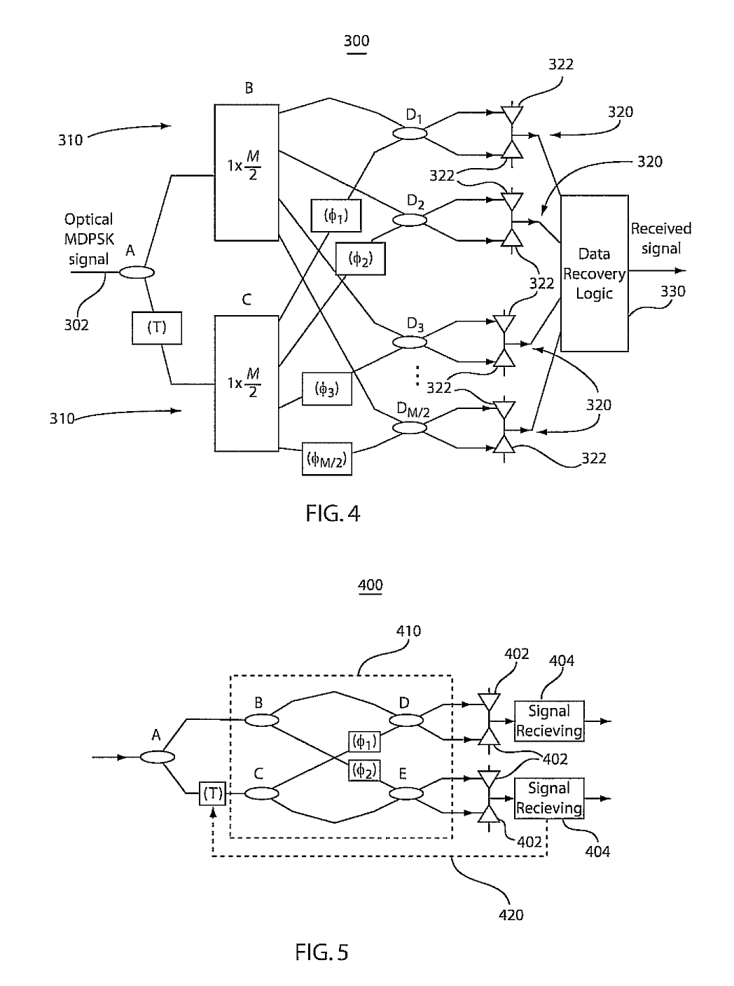

Referring to FIG. 4, an optical MDPSK demodulator 300 with M/2 delay interferometers B and C for optical MDPSK signal demodulation which share a common optical delay (T) is illustratively shown in accordance with the present principles. The common optical delay can have a value that is close to one symbol period (e.g., within up to about 30%). It can be shown that one symbol period, “colorless” delay (about 10% off from one symbol period in the 40 G case), and partial delay (about 30% off from one symbol period) all have applications in practical systems.

An incoming optical MDPSK signal 302 is split by an optical coupler A (e.g. a 3 dB optical coupler), and one branch (optical path AC) has an optical delay T. Each of the two branches 310 after the coupler A is further split into M/2 branches 320 by either optical splitter B or C. B and C are

$$1 \times \frac{M}{2}$$

optical couplers. One output from optical splitter B will be combined and interfere with one output from optical splitter C at couplers D₁, D₂, D₃, . . . D_{M/2}. The D couplers may be, e.g., 3 dB couplers. The optical interference paths are ABD₁ and ACD₁, ABD₂ and ACD₂, ABD₃ and ACD₃, . . . ABD_{M/2} and ACD_{M/2}. A data recovery circuit 330 may include logic employed to determine bits or symbol information from the input signal.

As a comparison, in FIG. 2, the delay interferometers B₁C₁, B₂C₂, B₃C₃, . . . , and B_{M/2}C_{M/2} are independent from each other. Please note that the phase biases φ₁, φ₂, φ₃, . . . φ_{M/2} in FIG. 4 are not necessarily the same as those in FIG. 2. As the extra phase change caused by optical splitter B and C needs to be taken into consideration. The phase shift can also be achieved by micro optical path delay (there is no specific phase shifter device in this case) or by an optical phase shifting device.

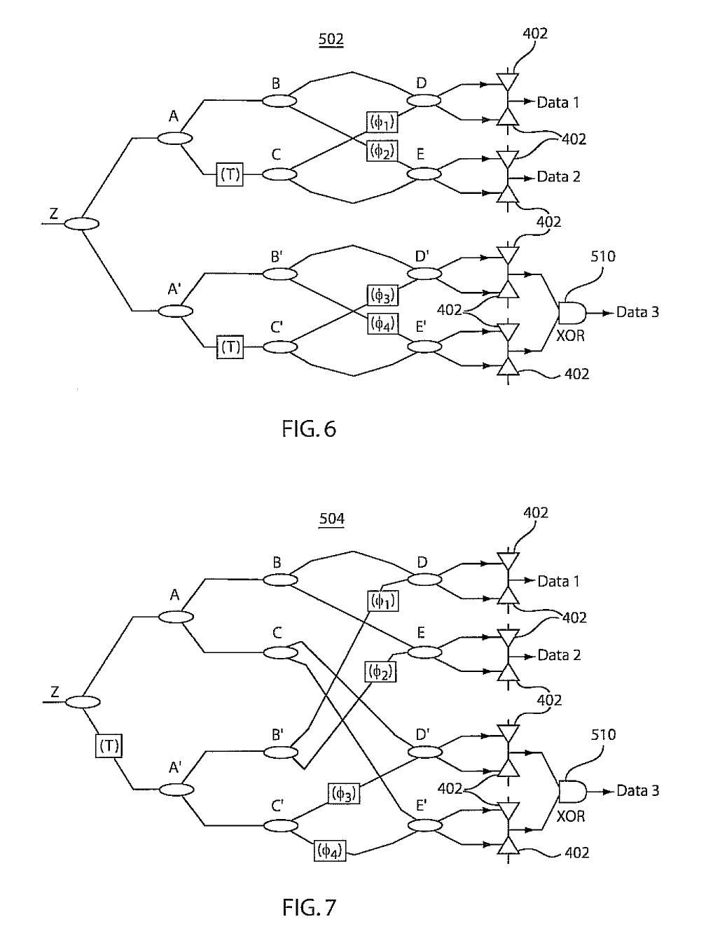

Although balanced detectors 322 are drawn in FIG. 6, they can be replaced by single-end detectors for lower system cost if the reduction of receiver sensitivity is acceptable. Please note that optical splitters B and C do not have to be based on one single device, such as star couplers, and they can use multiple couplers, such as, e.g., multiple 3 dB couplers.

Compared with the conventional design in FIG. 2, the present design has a common optical delay T for all the delay interferometers. Therefore, we can tune the optical delay T at one optical path to optimize all the delay interferometers. Such a feature can provide many system advantages. For example: (1) the optical delay T should be equal to or close to one symbol period to guarantee sufficient overlap of neighboring bits. At the same time, fT in equation (1) should be an integer to get correct optical MDPSK signal demodulation. In WDM communications, the incoming optical signal can be at different wavelengths, and therefore, T should be tuned to match the wavelength of the incoming optical signal. With the conventional design in FIG. 2, M/2 optical paths (one of the arms of delay interferometers B₁C₁, B₂C₂, B₃C₃, . . . , and B_{M/2}C_{M/2}) need to be precisely tuned for optimal interference, while the design in FIG. 4 needs precise tuning of only one optical path (AB or AC).

(2) In optical communications, the frequency of the laser in the transmitter may drift over time, and cause fT to deviate from an integer, which results in degradations of signal receiving. In real systems, electrical feedback control over T may be necessary to track the laser frequency drift. Based on similar reasons to (1), the conventional design needs M/2 feedback loops to control all the delay interferometers while the present design needs only one feedback control loop.

(3) when the symbol rate of the incoming signal changes, the optical delay T should be adjusted. With the present design of FIG. 4, optical delay T can be tuned in one optical path to match incoming signals at different symbol rates.

(4) From a device fabrication point of view, the present design of FIG. 4 can have lower cost than the conventional design (FIG. 2), since the present design requires less tuning paths.

A precondition includes that only T needs to be tuned and the phase shifts (φ₁, φ₂, φ₃, . . . φ_{M/2}) can be kept when the wavelength of an incoming optical signal changes. Within the optical WDM communication bands, we can show that this precondition holds with very small errors. From equation (1), the delay interferometer works only when fT is an integer and φ_{DI} (one of φ₁, φ₂, φ₃, . . . and φ_{M/2}) is fixed.

Assume φ_{DI}=2πτ, where τ is decided by the optical interferometer. With current a thermal packaging technologies, τ can be fixed and kept stable. When the optical interferometer is optimized for lightwave frequency fₒ, we have rₒ. The phase error caused by lightwave frequency change becomes

$$\begin{matrix}{φ}_{DI} - {φ}_{DI 0} = 2 π f {τ}_{0} - 2 π {f}_{0} {τ}_{0} \\ = 2 {πτ}_{0} ( f - {f}_{0} ) \\ = {φ}_{DI 0} \frac{( f - {f}_{0} )}{{f}_{0}}\end{matrix} \qquad ( 2 )$$

Therefore, the relative phase bias change is the same as the relative frequency change. Within C band (191.0 THz-195.90 THz), L band (186.0 THz-190.90 THz), or S band (196.0 THz-200.90 THz), the device can be optimized at the central wavelength of the band, and the relative phase bias error can be within ±1.3%, ±1.3%, and ±1.2%, respectively. Since the relatively laser frequency drift is far less than 1%, the phase bias error caused by laser frequency drift can be neglected.

Assume f₀T₀=N₀. Considering T₀ is about 50 ps for 40 Gb/s DQPSK signals and 20 ps for 100 Gb/s DQPSK signals, N₀ is about 10³˜10⁴. Therefore, the change of the product of fT due to lightwave carrier frequency change can be:

$$\begin{matrix}C - {N}_{0} = f {T}_{0} - {f}_{0} {T}_{0} \\ = ( f - {f}_{0} ) {T}_{0} \\ = {N}_{0} \frac{( f - {f}_{0} )}{{f}_{0}}\end{matrix} \qquad ( 3 )$$

Since N₀ is quite large, C-N₀ can be large and C is not necessarily an integer even with small laser frequency drift.

Referring to FIG. 5, a design for an optical DQPSK signal demodulator 400 is illustratively shown. Demodulator 400 includes optical couplers A, B, C, D, E, which may include, e.g., 3 dB optical couplers. φ₁=π/4 and φ₂=−π/4. Photodetectors 402 are included as before. In addition, signal receiving circuits 404 are employed to receive and/or process data.

When the incoming optical DQPSK signal is at different wavelengths, optical delay (T) can be tuned to achieve optimal system performance. When the wavelength of the incoming signal is at a certain wavelength range, such as S, C, or L band on international telecommunication union (ITU) grids, (φ₁) and (φ₂) can be fixed, and the wavelength differences bring very small deviations from ideal parameters. Therefore, a portion 410 can be optimized and fixed during device fabrication, and does not need to be tuned in system operations. Another feature of the device 400 is that we can tune the optical delay (T) for systems at different symbol rates.

Because of the laser frequency drift on a transmitter side, the optical delay (T) needs to be tuned to track the change of the laser frequency. DQPSK demodulator 400 includes a feedback control 420 to provide tuning adjustment for delay T. Advantageously, we use only one feedback control loop 420 to achieve stable operation of two (or more) delay interferometers.

Referring to FIGS. 6 and 7, designs for optical 8DPSK demodulators 502 and 504 are illustratively depicted. A coupler Z is employed to split the input signal. Demodulators 502 and 504 employ four interferometers B, C, D and E in each branch 506. Demodulator 502 is based on the optical DQPSK demodulator in FIG. 5, and demodulator 504 is based on the design shown in FIG. 4. Multiple couplers (e.g., 3 dB) may be employed instead of optical splitters. Data 1, data 2 and data 3 outputs are provided. Data 3 is the output of an exclusive OR (XOR) gate 510.

Referring FIG. 8, an optical 8DPSK signal demodulator 602 is illustratively shown using only two interferometers BD and CE. An electronic processing circuit 604 is employed to provide a third data output (data 3) based on data 1 and data 2.

When the optical MDPSK demodulator has reasonably large tolerance to laser frequency drift and the wavelengths of the incoming signals are on ITU grids or have good periodicity, the optical MDPSK demodulator can be made passive and “colorless”. Here “colorless” means that the same passive device can be used for incoming signals on ITU grids. The basic design of a “colorless” demodulator is to match its free spectral range (FSR, it is defined as FSR=1/T) with ITU grids and at the same time keep T close to optical signal symbol period. A passive and “colorless” optical MDPSK demodulator can be built in accordance with the present principles. This can bring cost advantages, since some optical elements can be shared by multiple delay interferometers. The implementation scheme of optical DQPSK demodulators described below shows this feature.

Implementations of new optical DQPSK demodulator designs: Known technologies for demodulators are based on integrated optics, where an integrated waveguide is used. Generally speaking, such an integrated device requires temperature control, and may have significant polarization dependency, such as polarization dependent loss and polarization dependent free-spectral range.

The present embodiments can be developed with optical fibers or free-space optics. With a thermal free-space optics, the devices using the new design can achieve high system performance, especially low polarization dependency.

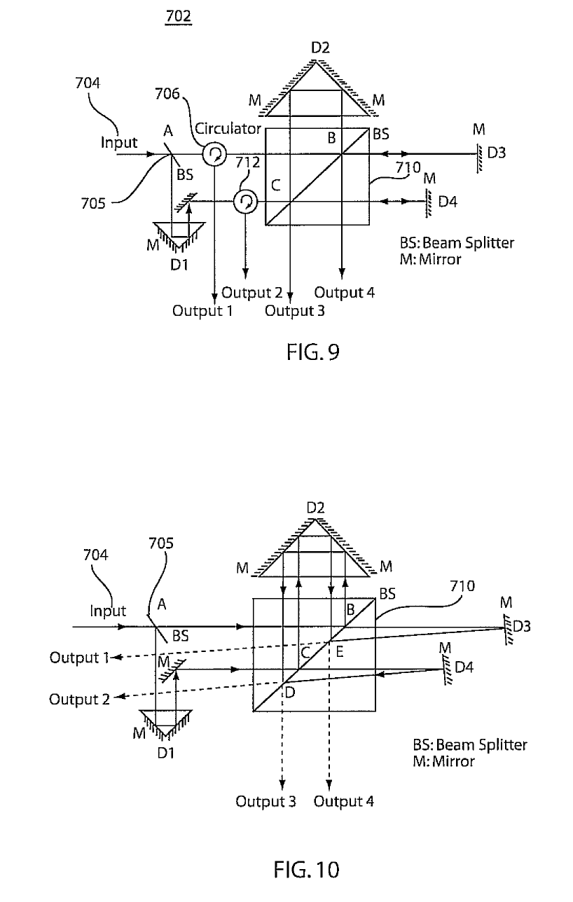

Referring to FIG. 9, an implementation of a new optical DQPSK demodulator design 702 using free-space optics is illustratively depicted. An incoming DQPSK signal (Input) 704 is split by a beam splitter (BS) 705 with a splitting ratio of 50:50 at point A. One of the two outputs after the beam splitter 705 at A passes through an optical circulator 706 and reaches point B, and 50% of the light is reflected toward a corner mirror D2 and reflected back to a beam splitter 710 at point C, and the other 50% of the light goes toward mirror D3 and is reflected back to the beam splitter 710 at point B. The other output after beam splitter 705 at A is reflected by corner mirror D1, passes through an optical circulator 712 and reaches point C. The light beam AD1C will experience similar splitting and reflections as light beam AB. In the end, light beam ABD2C interferes with light beam AD1CD4C at point C, and produces outputs 2 and 3. Output beam 2 exits through an optical circulator 712. The light beam ABD3B interferes with light beam AD1CD2B at point B and produces output beams 1 and 4. Output beam 1 exits through an optical circulator 706. In this design, optical corner mirrors D1 or D2 can be tuned for adjustment of optical delay T.

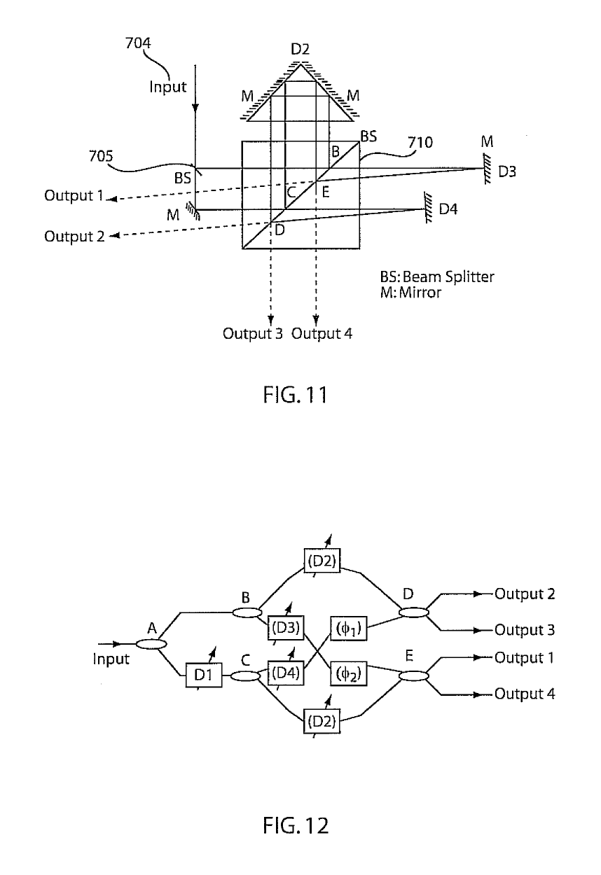

Because of the difficulties of building optical circulators, we show some other implementation designs, as shown in FIGS. 10 and 11. Please note that optical path BD2D is equal to optical path CD2B in FIGS. 10 and 11 (The corner mirror D2 has a right angle.). In the designs shown in FIGS. 10 and 11, tuning optical corner mirror D1 or D2 can adjust two optical paths and two interferometers. Optical mirrors D3 and D4 should be adjusted for optimal interference during fabrication, and fixed when the fabrication process is finished. Note that the optical paths shown in FIG. 10 and FIG. 11 can be in two dimensions or three dimensions. FIGS. 10 and 11 show alternate implementations of the new optical DQPSK demodulator design using free-space optics.

To further explain the fabrication process, we re-draw the optical paths in FIG. 10 using optical couplers, as shown in FIG. 12. Referring to FIG. 12 with continued reference to FIG. 10, three possible ways of doing optical path adjustment and device operations are illustratively shown. Note that there may be many other schemes to adjust the optical path length and align the optical elements. (1) Fix D2; tune D3 such that BE−CE=(φ₂); tune D4 such that CD−BD=(φ₁); tune D1 such that AC−AB=(T). As for operation, D1 will be tuned to match incoming signal at different wavelengths or controlled by a feedback loop. (2) Fix D2; Fix D1, and assume AC−AB=TX; tune D4 such that CD−BD=(T−Tₓ, φ₁); tune D3 such that CE−BE=(T−Tₓ, φ₂). As for operation, D1 will be tuned to match the incoming signal at different wavelengths or controlled by a feedback loop (not shown). (Here, Tₓ is a random optical delay, and we assume Tₓ<T.) (3) Fix D1, and AC−AB=Tₓ; Fix D2; tune D3 such that CE−BE=(T−Tₓ, −φ₂); tune D4 such that BD−CD=(T+Tₓ, −φ₁); As for operation, D2 will be tuned to match incoming signal at different wavelengths or controlled by a feedback loop (not shown). Here the precise tuning can be monitored in situ through the free spectral range of the output.

Having described preferred embodiments of a demodulator system and method using multilevel differential phase shift keying (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A demodulator, comprising:
an optical coupler configured to receive an input signal, the optical coupler coupling the signal to an even number of branches;
each branch including at least one interferometer configured to split, combine and interfere with an optical signal from one of within the branch or from another branch; and
a common optical delay disposed on one of every two branches between the optical coupler and the interferometer of the branch.

2. The demodulator as recited in claim 1, wherein the common optical delay is tunable and common to all delay interferometers in the demodulator such that one optical path is tuned to optimize all interferometers in the demodulator.

3. The demodulator as recited in claim 2, wherein the common optical delay is tunable by a feedback loop.

4. The demodulator as recited in claim 1, wherein the common optical delay is substantially equal to one symbol period to provide overlap for interference between neighboring bits.

5. The demodulator as recited in claim 1, wherein a product of carrier frequency and optical delay is maintained at an integer value.

6. The demodulator as recited in claim 1, wherein each interferometer includes an optical component to further split a signal from the optical coupler and the further split signal includes a path to an interferometer in another branch.

7. The demodulator as recited in claim 1, wherein each interferometer includes an optical component to further split a signal from the optical coupler and the further split signal experiences phase shift between interferometers.

8. The demodulator as recited in claim 1, wherein each interferometer includes an optical component to further split a signal from the optical coupler into a plurality of optical paths and the further split signal includes paths to an interferometer in another branch and to the interferometer within the branch.

9. The demodulator as recited in claim 1, wherein the demodulator includes a multilevel differential quadrature pulse shift keying (mDQPSK) demodulator, where M is the number of level and M/2 is the number of branches.

10. The demodulator as recited in claim 8, wherein one common optical delay is employed for M levels.

11. The demodulator as recited in claim 8, wherein M/2 common optical delays are included for M levels.

12. The demodulator as recited in claim 1, wherein an eight differential pulse shift keying (8DPSK) demodulator consists of two interferometers.

13. A demodulator using free-space optics, comprising:
an optical coupler configured to receive an input signal, the optical coupler coupling the signal to an even number of branches;
each branch including at least one interferometer configured to split, combine and interfere with an optical signal from one of within the branch or from another branch, wherein each interferometer includes an optical component to further split a signal from the optical coupler and the further split signal is provided on optical paths which include phase shifters to phase bias delayed paths between interferometers; and
a common optical delay disposed on one of every two branches between the optical coupler and the interferometer of the branch, wherein the phase shifters and the common optical delay are adjustable by adjusting free-space optical components.

14. The demodulator as recited in claim 13, wherein the common optical delay is tunable and common to all delay interferometers in the demodulator such that one optical path is tuned to optimize all interferometers in the demodulator.

15. The demodulator as recited in claim 13, wherein the common optical delay is substantially equal to one symbol period to provide overlap for interference between neighboring bits.

16. The demodulator as recited in claim 13, wherein a product of carrier frequency and optical delay is maintained at an integer value.

17. The demodulator as recited in claim 13, wherein each interferometer includes an optical component to further split a signal from the optical coupler and the further split signal includes a path to an interferometer in another branch.

18. The demodulator as recited in claim 13, wherein the demodulator includes a multilevel differential pulse shift keying (MDPSK) demodulator, where M is the number of level and M/2 is the number of branches.

19. The demodulator as recited in claim 18, wherein one common optical delay is employed for M levels.

20. The demodulator as recited in claim 18, wherein M/2 common optical delays are included for M levels.

21. The demodulator as recited in claim 13, wherein the free-space optical components include at least one of mirrors and beam splitters.

22. A demodulation method, comprising:
splitting an input signal to an even number of optical branches, each branch including at least one interferometer configured to split, combine and interfere with an optical signal from one of within the branch or from another branch; and
providing a single common optical delay disposed on one of every two branches between the optical coupler and the interferometer of the branch.

23. The demodulator as recited in claim 22, further comprising tuning the common optical delay to optimize all interferometers in the demodulator.

24. The demodulator as recited in claim 22, wherein the common optical delay is substantially equal to one symbol period to provide overlap for interference between neighboring bits.

25. The demodulator as recited in claim 22, wherein a product of carrier frequency and optical delay is maintained at an integer value.
